(19) United States
(12) Patent Application Publication
(10) Pub. No.: US 2020/0099973 A1
(43) Pub. Date: Mar. 26, 2020

(54) INFORMATION PROCESSING SYSTEM, TERMINAL APPARATUS, AND NON-TRANSITORY COMPUTER READABLE MEDIUM

(71) Applicant: FUJI XEROX CO., LTD., Tokyo (JP)

(72) Inventors: Ryota MIZUTANI, Kanagawa (JP); Suresh MURALI, Kanagawa (JP); Shingo UCHIHASHI, Kanagawa (JP)

(73) Assignee: FUJI XEROX CO., LTD., Tokyo (JP)

(21) Appl. No.: 16/572,589

(22) Filed: Sep. 16, 2019

(30) Foreign Application Priority Data
Sep. 25, 2018 (JP) 2018-179068

(51) Int. Cl. H04N 21/2662; H04N 21/2343

(52) U.S. Cl. CPC H04N 21/2662; H04N 21/23439; H04N 21/234381

(57) ABSTRACT

An information processing system includes a video data memory that stores, for a specific video, plural pieces of video data having different resolutions for at least one bit rate, plural pieces of video data having different bit rates for at least one resolution, or plural pieces of video data having plural frame rates associated with a combination of one bit rate and one resolution, a condition determining unit that determines, in response to a change in contents of the video, a minimum bit rate, a resolution, and a frame rate that secure a predetermined image quality or higher from among plural combinations of a resolution, a frame rate, and a bit rate that does not exceed a communication speed, and a transmitting unit that transmits, to a playback apparatus that plays back the video, video data having a combination of one bit rate, one resolution, and one frame rate from among the plural pieces of video data having different resolutions for at least one bit rate, the plural pieces of video data having different bit rates for at least one resolution, or the plural pieces of video data having the plural frame rates associated with the combination of one bit rate and one resolution.

### CROSS-REFERENCE TO RELATED APPLICATIONS

This application is based on and claims priority under 35 USC 119 from Japanese Patent Application No. 2018-179068 filed Sep. 25, 2018.

### BACKGROUND

### (i) Technical Field

The present disclosure relates to an information processing system, a terminal apparatus, and a non-transitory computer readable medium.

### (ii) Related Art

For example, Japanese Unexamined Patent Application Publication No. 2017-157904 describes an information processing apparatus including an image quality information acquiring part and a bit rate determining part. The image quality information acquiring part acquires image quality information indicating the image quality of each segment of a video to be streamed at each bit rate. The bit rate determining part determines, as a bit rate of the video to be played back, one of a plurality of bit rates indicated by acquired bit rate information. When the image quality of the video at a candidate bit rate of a certain segment of the video satisfies a predetermined image quality condition, the bit rate determining part determines the candidate bit rate as a bit rate of the segment. When the image quality of the video at the candidate bit rate does not satisfy the image quality condition, the bit rate determining part determines a bit rate higher than the candidate bit rate as the bit rate of the segment.

### SUMMARY

Aspects of non-limiting embodiments of the present disclosure relate to the following circumstances. There has been employed a system in which a plurality of videos having different bit rates are prepared as video data to be used for streaming playback and a bit rate is selected depending on, for example, a playback condition of a playback apparatus that plays back the video.

For example, if a relatively high bit rate is set for a certain resolution or frame rate so as to stabilize the image quality irrespective of the contents of the video, the bit rate is excessive in a case in which the video shows, for example, many scenes with small motions. Thus, the data communication amount increases. In this case, the condition may be unfavorable to a user who wants to reduce the data communication amount. If a relatively low bit rate is merely set for a certain resolution or frame rate, the image quality decreases and the condition may be unfavorable to a user who wants to increase the playback image quality.

In related art, there has been prepared video data in which only one resolution or frame rate is associated with each of the plurality of bit rates.

It is desirable that combinations of the bit rate and the resolution or frame rate be selectable and the data communication amount be reduced compared with the case in which a relatively high bit rate is set for a certain resolution or frame rate irrespective of the contents of the video.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising a video data memory that stores, for a specific video, a plurality of pieces of video data having different resolutions for at least one bit rate, a plurality of pieces of video data having different bit rates for at least one resolution, or a plurality of pieces of video data having a plurality of frame rates associated with a combination of one bit rate and one resolution, a condition determining unit that determines, in response to a change in contents of the video, a minimum bit rate, a resolution, and a frame rate that secure a predetermined image quality or higher from among a plurality of combinations of a resolution, a frame rate, and a bit rate that does not exceed a communication speed, and a transmitting unit that transmits, to a playback apparatus that plays back the video, video data having a combination of one bit rate, one resolution, and one frame rate from among the plurality of pieces of video data having different resolutions for at least one bit rate, the plurality of pieces of video data having different bit rates for at least one resolution, or the plurality of pieces of video data having the plurality of frame rates associated with the combination of one bit rate and one resolution.

### BRIEF DESCRIPTION OF THE DRAWINGS

Exemplary embodiments of the present disclosure will be described in detail based on the following figures, wherein:

FIG. 1 illustrates an example of an overall video delivery system of exemplary embodiments;

FIG. 2 illustrates an overview of streaming of the exemplary embodiments;

FIG. 3 illustrates the functional configurations of a server apparatus and a terminal apparatus of the exemplary embodiments;

FIG. 4 illustrates relationships between a bit rate and a resolution of segment data stored in a segment data storing part;

FIG. 5 illustrates an example of video quality evaluation results obtained by an image quality evaluating part;

FIG. 6 is a flowchart of an operation in an image quality priority mode of the video delivery system of the exemplary embodiments;

FIG. 7 is a flowchart of an operation in a communication amount priority mode of the video delivery system of the exemplary embodiments;

FIG. 8 illustrates relationships between the bit rate and the resolution of the segment data in another example;

FIG. 9 illustrates relationships between the bit rate and the resolution of the segment data in still another example; and

FIG. 10 illustrates a video quality index of a second exemplary embodiment.

### DETAILED DESCRIPTION

Exemplary embodiments of the present disclosure are described blow with reference to the accompanying drawings.

### First Exemplary Embodiment

[Video Delivery System 1]

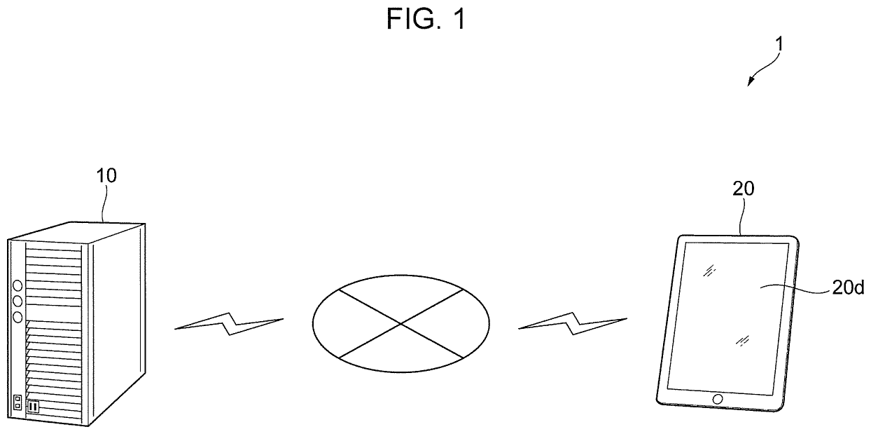

FIG. 1 illustrates an example of an overall video delivery system 1 of a first exemplary embodiment.

As illustrated in FIG. 1, the video delivery system 1 of this exemplary embodiment includes a server apparatus 10 (example of an information processing apparatus) that delivers a video, and a terminal apparatus 20 (example of a playback unit) that plays back the delivered video on a screen 20d. In the video delivery system 1, the server apparatus 10 and the terminal apparatus 20 may mutually communicate information via a network.

The network is not particularly limited as long as the network is a communication network for use in data communication between the apparatuses. For example, the network may be a local area network (LAN), a wide area network (WAN), or the Internet. A communication line for use in data communication may be established by wire, by wireless, or by wire and wireless in combination. The apparatuses may be connected together via a plurality of networks or communication lines by using a relay apparatus such as a gateway apparatus or a router.

In the example illustrated in FIG. 1, a single server apparatus 10 is illustrated but the server apparatus 10 is not limited to the single server machine. Functions of the server apparatus 10 may be implemented by being distributed among a plurality of server machines provided on a network (so-called cloud environment or the like).

In the example illustrated in FIG. 1, a single terminal apparatus 20 is illustrated as the terminal apparatus 20 but a plurality of terminal apparatuses 20 may be connected.

The video delivery system 1 of this exemplary embodiment streams a video to a playback apparatus that is used by a user. The video streaming is delivery of a video by a mechanism that divides the video into a plurality of segments and sequentially plays back pieces of segment data indicating videos of the respective segments while transmitting and receiving the pieces of segment data in playback order. The segment data is data indicating a segment of, for example, about 1 second to about 10 seconds.

The terminal apparatus 20 plays back a video streamed in the video delivery system 1. The terminal apparatus 20 is carried by a user for use in various places. The server apparatus 10 stores a plurality of pieces of segment data indicating a single video as a whole and streams the video by sequentially transmitting the pieces of segment data in playback order.

In the video delivery system 1, a video whose bit rate and resolution are changeable during playback is streamed in conformity with, for example, a standard called Moving Picture Experts Group (MPEG)-Dynamic Adaptive Streaming over HTTP (DASH). That is, in the streaming of this exemplary embodiment, pieces of segment data having a plurality of resolutions for one bit rate or pieces of segment data having a plurality of bit rates for one resolution are prepared and segment data having one bit rate and one resolution is delivered from among the plurality of pieces of segment data depending on conditions.

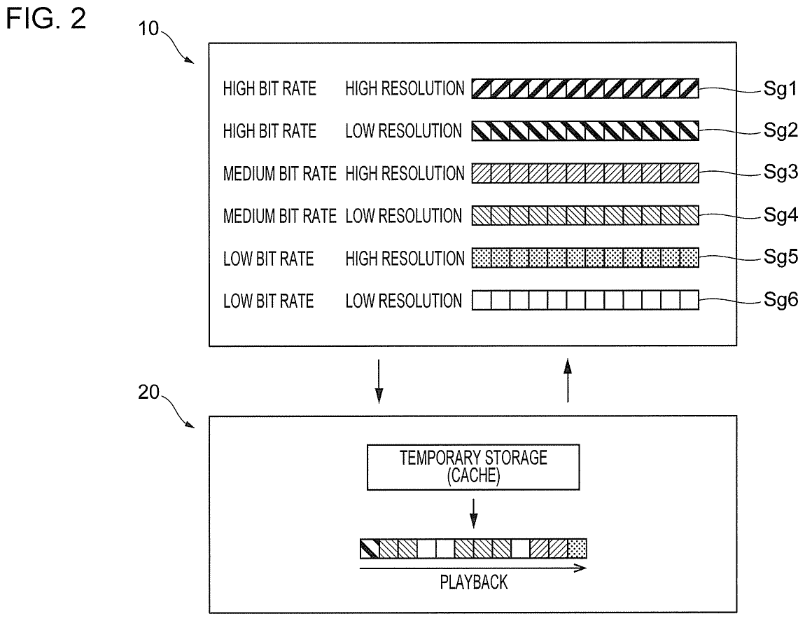

FIG. 2 illustrates an overview of the streaming of this exemplary embodiment.

The server apparatus 10 of this exemplary embodiment stores a plurality of pieces of segment data having different resolutions for one bit rate or a plurality of pieces of segment data having different bit rates for one resolution. As a specific example, the server apparatus 10 stores a segment data group Sg1 of a video having a high bit rate and a high resolution, a segment data group Sg2 of a video having a high bit rate and a low resolution, a segment data group Sg3 of a video having a medium bit rate and a high resolution, a segment data group Sg4 of a video having a medium bit rate and a low resolution, a segment data group Sg5 of a video having a low bit rate and a high resolution, and a segment data group Sg6 of a video having a low bit rate and a low resolution as illustrated in FIG. 2.

In this exemplary embodiment, the bit rate is the amount of data transmitted or received in 1 second (for example, the unit is megabit per second (Mbps)).

When the terminal apparatus 20 of this exemplary embodiment requests video streaming, the terminal apparatus 20 specifies a bit rate and a resolution of a video to be delivered. The server apparatus 10 sequentially reads pieces of segment data from a segment data group having the specified bit rate and the specified resolution and transmits the pieces of segment data. The terminal apparatus 20 temporarily stores the received pieces of segment data and reads and plays back the cached pieces of segment data.

During playback of a video, the terminal apparatus 20 may request delivery while specifying a bit rate and a resolution different from those of the video that is being played back. When the server apparatus 10 receives the request, the server apparatus 10 transmits pieces of segment data having the new bit rate and the new resolution specified by the terminal apparatus 20. When the terminal apparatus 20 receives the pieces of segment data, the terminal apparatus 20 plays back a video indicated by the pieces of segment data having the new bit rate and the new resolution subsequently to the video indicated by the pieces of segment data having the original bit rate and the original resolution. The segment data group (Sg1 to Sg6) indicates a video in which a plurality of segments are sequentially streamed and whose bit rate and resolution are changeable during playback.

Determination of the bit rate and the resolution by the terminal apparatus 20 is described in detail later.

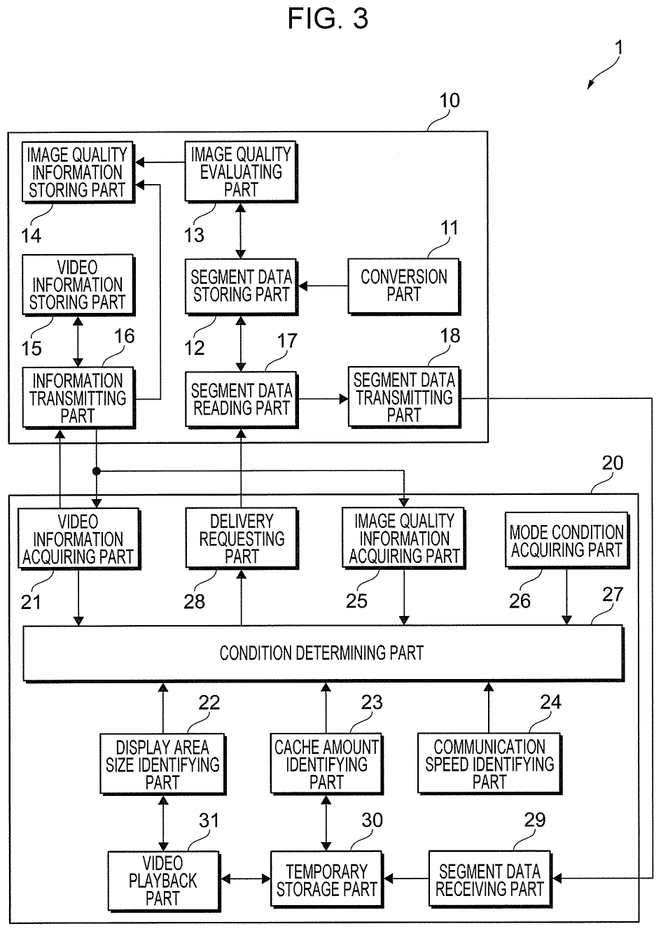

FIG. 3 illustrates the functional configurations of the server apparatus 10 and the terminal apparatus 20 of this exemplary embodiment.

As illustrated in FIG. 3, the server apparatus 10 includes a conversion part 11 that converts a bit rate and a resolution of an original video, a segment data storing part 12 that stores segment data to be delivered, and an image quality evaluating part 13 that evaluates the image quality of the segment data. The server apparatus 10 further includes an image quality information storing part 14 that stores the evaluation of image quality, a video information storing part 15 that stores the bit rate and the resolution of the video, and an information transmitting part 16 that transmits information on the image quality, the bit rate, and the resolution of the video. The server apparatus 10 further includes a segment data reading part 17 that reads a request for segment data from a client, and a segment data transmitting part 18 that transmits the segment data.

### (Conversion Part 11)

When a self-owned apparatus stores a video that is the original of videos having the plurality of bit rates described above, the conversion part 11 converts the bit rate of the video. For example, the conversion part 11 of this exemplary embodiment converts the bit rate and the resolution by reducing the resolution of the original video, reducing the frame rate, or reducing both the resolution and the frame rate.

As described later, the conversion part 11 of this exemplary embodiment generates videos having eight different combinations of the bit rate and the resolution by converting the original video.

In this exemplary embodiment, in order to reduce the communication amount, for example, a video indicated by pieces of segment data each encoded (compressed) as data indicating a reference frame determined for each segment of the video and a difference from the frame is used as the original video. The conversion part 11 generates new segment data having the converted bit rate and the converted resolution from each segment data of the original video. The conversion part 11 sends the generated segment data having each bit rate to the segment data storing part 12.

### (Segment Data Storing Part 12)

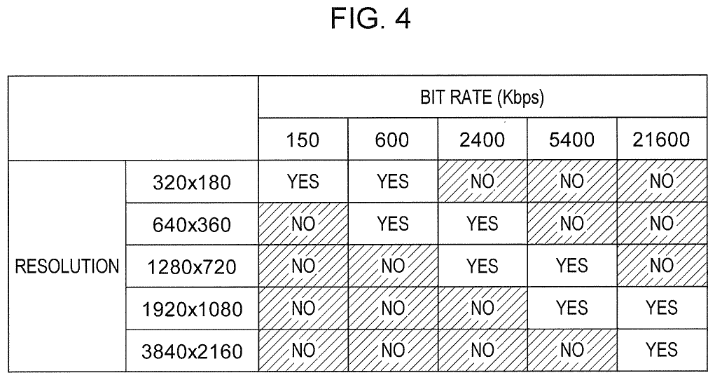

FIG. 4 illustrates relationships between the bit rate and the resolution of the segment data stored in the segment data storing part 12.

The segment data storing part 12 (example of a video data memory) stores pieces of segment data of a video to be streamed from the server apparatus 10 to the terminal apparatus 20. The segment data storing part 12 stores pieces of segment data indicating videos having the plurality of combinations of the bit rate and the resolution that are received from the conversion part 11.

As illustrated in FIG. 4, the segment data storing part 12 of this exemplary embodiment stores nine combinations of the bit rate and the resolution, which are segment data of the original video that has a bit rate of 21600 Kbps and a resolution of 3840×2160, segment data having a bit rate of 21600 Kbps and a resolution of 1920×1080, segment data having a bit rate of 5400 Kbps and a resolution of 1920×1080, segment data having a bit rate of 5400 Kbps and a resolution of 1280×720, segment data having a bit rate of 2400 Kbps and a resolution of 1280×720, segment data having a bit rate of 2400 Kbps and a resolution of 640×360, segment data having a bit rate of 600 Kbps and a resolution of 640×360, segment data having a bit rate of 600 Kbps and a resolution of 320×180, and segment data having a bit rate of 150 Kbps and a resolution of 320×180.

The nine combinations of the bit rate and the resolution that are stored in the segment data storing part 12 are based on image quality evaluation results obtained by the image quality evaluating part 13. Details thereof are described later.

In the first exemplary embodiment, it is assumed that one frame rate is combined with one bit rate and one resolution. This assumption is made for convenience of description. The first exemplary embodiment does not exclude a case in which a plurality of frame rates are associated with one bit rate and one resolution.

### (Image Quality Evaluating Part 13)

The image quality evaluating part 13 may evaluate the image quality of a video subjected to bit rate conversion prior to segmentation or may evaluate the image quality of a video indicated by pieces of segment data stored in the segment data storing part 12. For example, the image quality evaluating part 13 performs evaluation by comparing a segment of the video that has a reference bit rate with a segment of the video that has a bit rate to be evaluated. The image quality evaluating part 13 evaluates the image quality of the video by using, as a reference bit rate and a reference resolution, a highest bit rate and a highest resolution among the bit rates and the resolutions changeable in video streaming. In this exemplary embodiment, the image quality evaluating part 13 evaluates the image quality by using the bit rate and the resolution of the original video as references.

When the bit rate is converted, the image quality is more likely to decrease as the bit rate decreases. For example, a color image may be displayed as a monochrome image or block noise may occur. Therefore, the image quality evaluating part 13 compares frames of common scenes in a common segment of a reference video and a comparative video and evaluates the image quality based on the degree of difference between the frame of the video to be evaluated and the frame of the reference video. This comparison may be made for a single frame or two or more frames in one segment (including all the frames).

For example, the image quality evaluating part 13 of this exemplary embodiment evaluates the image quality based on a difference between frames by using structural similarity (SSIM). For example, the image quality evaluating part 13 shows the evaluation result by using values ranging from 0 to 1. The value “1” means that the image quality is high because of no difference from a reference image. As the value decreases, the difference from the reference image increases. This means that the image quality decreases. The image quality evaluating part 13 sends each evaluation result to the image quality information storing part 14.

Although the image quality evaluating part 13 of this exemplary embodiment evaluates the image quality of the video by using the SSIM as described above, the image quality evaluation method is not limited to the SSIM. The image quality evaluating part 13 only needs to evaluate the degree of image deterioration in the compressed video relative to the original video. A technology such as a mean square error (MSE) method, a peak signal to noise ratio (PSNR) method, or a color histogram may be used.

### (Image Quality Information Storing Part 14)

The image quality information storing part 14 stores image quality information indicating the image quality of the video that is evaluated by the image quality evaluating part 13. The image quality information storing part 14 stores the evaluation result supplied from the image quality evaluating part 13 in association with the corresponding bit rate and segment.

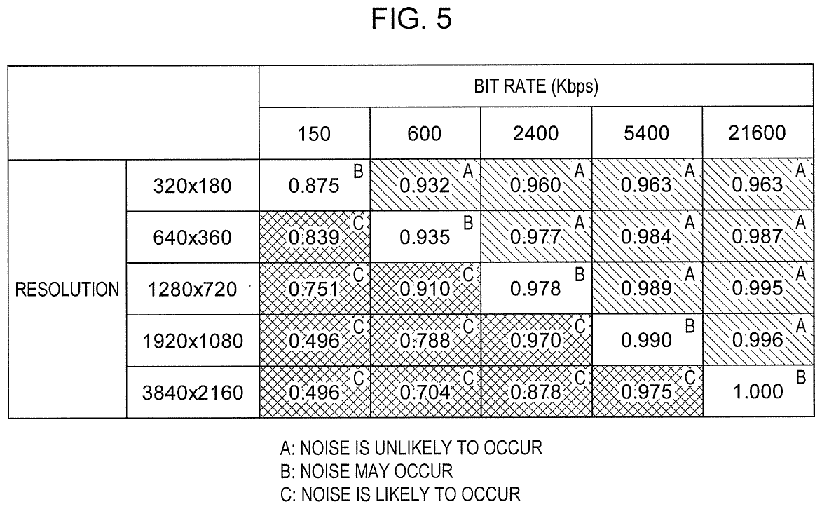

FIG. 5 illustrates an example of video quality evaluation results obtained by the image quality evaluating part 13.

The example illustrated in FIG. 5 shows SSIM evaluation results for all the combinations including the combinations of the bit rate and the resolution for use in this exemplary embodiment. The example of FIG. 5 shows SSIM values for 25 patterns that are combinations of five bit rates and five resolutions.

In the example illustrated in FIG. 5, the bit rate of the original image is 21600 Kbps and the resolution thereof is 3840×2160. Thus, the SSIM value of the combination of the bit rate of 21600 Kbps and the resolution of 3840×2160 is 1 and the image quality is highest.

As illustrated in FIG. 5, at the same resolution, the image quality tends to increase as the bit rate increases and the image quality tends to decrease as the bit rate decreases.

As illustrated in FIG. 5, at each bit rate, there is a combination of the resolution and the bit rate that maximizes the image quality. For example, in the case of the bit rate of 2400 Kbps, the combination with the resolution of 1280×720 maximizes the image quality. In the case of the bit rate of 2400 Kbps, the image quality decreases when the resolution is lower than 1280×720. In the case of the bit rate of 2400 Kbps, the image quality decreases when the resolution is higher than 1280×720. The same tendency applies to the other bit rates.

Thus, the image quality does not always increase when the bit rate or the resolution is merely increased. It is necessary to identify the image quality in consideration of both the bit rate and the resolution.

FIG. 5 also illustrates information related to the occurrence of noise such as block noise in a case in which a video having each combination of the bit rate and the resolution is played back. For example, the block noise is likely to occur depending on video contents such as motions of image elements that constitute the video or the speed of scene switching though the block noise is also affected by the performance of the terminal apparatus 20 that plays back the video. The symbol “A” illustrated in FIG. 5 represents a combination evaluated such that the noise is unlikely to occur. The symbol “B” represents a combination evaluated such that the noise may occur. The symbol “C” represents a combination evaluated such that the noise is likely to occur.

For example, in the case of the bit rate of 2400 Kbps, the image quality is highest at the resolution of 1280×720. In this combination, however, noise may occur during playback of the video. In the case of the bit rate of 2400 Kbps, the noise is unlikely to occur by setting the resolution of 640×360 that is lower than the resolution of 1280×720 though the image quality slightly decreases.

In the video delivery system 1 of this exemplary embodiment, the combination of the bit rate and the resolution to be stored in the segment data storing part 12 is determined based on the image quality evaluation performed by the image quality evaluating part 13. That is, the segment data storing part 12 of this exemplary embodiment stores, at each bit rate, pieces of segment data having a combination with a resolution that maximizes the image quality and a combination with a resolution lower than the resolution that maximizes the image quality. As illustrated in FIG. 4, in the segment data storing part 12, combinations of one bit rate and two different resolutions are provided and combinations of one resolution and two different bit rates are also provided.

For example, the segment data storing part 12 may store all the combinations of the bit rate and the resolution illustrated in FIG. 4. In this exemplary embodiment, however, the combination is limited to those described above because the storage resource that stores video data has a limit.

### (Video Information Storing Part 15)

The video information storing part 15 stores bit rate information indicating the plurality of bit rates and resolution information indicating the resolutions for the videos indicated by the pieces of segment data stored in the segment data storing part 12. The video information storing part 15 of this exemplary embodiment stores bit rate information and resolution information indicating the bit rates and the resolutions in the nine combinations described above.

### (Information Transmitting Part 16)

When the information transmitting part 16 receives request data described later that is transmitted from the terminal apparatus 20, the information transmitting part 16 reads, from the video information storing part 15, bit rate information and resolution information of a video identified by the request data and transmits the bit rate information and the resolution information to the terminal apparatus 20. Further, the information transmitting part 16 reads image quality information of the video from the image quality information storing part 14 and sends the image quality information to the terminal apparatus 20 together with the bit rate information and the resolution information.

### (Segment Data Reading Part 17)

When an external apparatus requests video streaming, the segment data reading part 17 reads pieces of segment data of a requested video. When the segment data reading part 17 receives specifying data transmitted from the terminal apparatus 20, the segment data reading part 17 reads a predetermined number of pieces of segment data in order from the beginning of the video from a segment data group having a bit rate specified by the specifying data.

The segment data reading part 17 performs processing of reading a predetermined number of pieces of segment data subsequently to the read pieces of segment data. The segment data reading part 17 repeats this processing at time intervals corresponding to a playback time of a part of the video that is indicated by the pieces of segment data read at a time or a time shorter than this playback time. If the specified bit rate and the specified resolution are changed during the playback, the segment data reading part 17 reads a predetermined number of pieces of segment data at a point subsequent to the current playback point from among pieces of segment data having a new bit rate and a new resolution. Every time the pieces of segment data are read, the segment data reading part 17 sends the read pieces of segment data to the segment data transmitting part 18.

### (Segment Data Transmitting Part 18)

The segment data transmitting part 18 (example of a transmitting unit) acquires the pieces of segment data from the segment data reading part 17. The segment data transmitting part 18 transmits the acquired pieces of segment data to the terminal apparatus 20 that is the source of transmission of the specifying data, that is, the source of request for the video streaming.

As described above, the video to be streamed in the video delivery system 1 of this exemplary embodiment is represented by the video having the original bit rate and the original resolution and the videos having the plurality of combinations of the bit rate and the resolution that are obtained by converting the original video. In the video delivery system 1 of this exemplary embodiment, pieces of segment data having a specified bit rate and a specified resolution are delivered to the terminal apparatus 20 from among the pieces of segment data indicating the videos having the plurality of combinations of the bit rate and the resolution.

### [Terminal Apparatus 20]

The terminal apparatus 20 includes a video information acquiring part 21 that acquires video information, and a display area size identifying part 22 that identifies the size of a display area where a video is played back. The terminal apparatus 20 further includes a cache amount identifying part 23 that identifies the cache amount of video data, a communication speed identifying part 24 that identifies a communication speed, and an image quality information acquiring part 25 that acquires image quality information related to the image quality of the video data. The terminal apparatus 20 further includes a mode condition acquiring part 26 that acquires a mode condition from the user, a condition determining part 27 that determines a video condition, and a delivery requesting part 28 that requests delivery of the video. The terminal apparatus 20 further includes a segment data receiving part 29 that receives segment data of the video, a temporary storage part 30 that caches the segment data of the video, and a video playback part 31 that plays back the video displayed on the screen 20d.

### (Video Information Acquiring Part 21)

The video information acquiring part 21 acquires transmitted bit rate information and supplies the acquired bit rate information to the condition determining part 27. When video streaming is requested, the video information acquiring part 21 acquires bit rate information indicating a plurality of bit rates of a video.

For example, when a link to a video placed on a webpage is operated on the terminal apparatus 20, the video information acquiring part 21 transmits request data for requesting bit rate information of the video from the server apparatus 10. The request data includes information for identifying the video, such as a uniform resource locator (URL).

### (Display Area Size Identifying Part 22)

The display area size identifying part 22 identifies the size of a display area (hereinafter referred to as a display area size) of a video to be streamed. The display area size identifying part 22 acquires information on the display area size of the video from the video playback part 31. Specifically, the display area size identifying part 22 acquires, as the display area size, the lengths of the long side and the short side of the display area of the video on the screen 20d. The display area size identifying part 22 sends display area size information indicating the acquired display area size to the condition determining part 27.

### (Cache Amount Identifying Part 23)

The cache amount identifying part 23 identifies a cache amount in streaming playback. The cache amount is the data amount of segment data temporarily stored for a part of the video to be played back by streaming.

The cache amount identifying part 23 refers to pieces of segment data temporarily stored in the temporary storage part 30 and identifies, as the cache amount, a playback time for a case in which the pieces of segment data to which reference is made are played back. For example, if the cached pieces of segment data indicate a video of 2 seconds, the cache amount identifying part 23 determines that the video of 2 seconds is cached. The cache amount identifying part 23 sends information indicating the seconds to the condition determining part 27 as cache amount information.

### (Communication Speed Identifying Part 24)

The communication speed identifying part 24 identifies a communication speed for reception of pieces of segment data of a video to be streamed. The communication speed identifying part 24 monitors the segment data receiving part 29 and identifies the data size of the pieces of segment data received by the segment data receiving part 29 per unit time as the communication speed. For example, if 10 megabits of segment data are received in 1 second, the communication speed identifying part 24 identifies 10 Mbps as the communication speed. The communication speed identifying part 24 sends communication speed information indicating the identified communication speed to the condition determining part 27.

Prior to the start of streaming, the communication speed identifying part 24 identifies the communication speed based on received data on information other than that for video delivery between the terminal apparatus 20 and the server apparatus 10. In this exemplary embodiment, the communication speed prior to the start of streaming is referred to as a pre-streaming communication speed.

The display area size identifying part 22, the cache amount identifying part 23, and the communication speed identifying part 24 described above perform their processing at time intervals in common with the time intervals at which the condition determining part 27 repeatedly determines the bit rate.

### (Image Quality Information Acquiring Part 25)

The image quality information acquiring part 25 acquires information indicating the image quality of each segment of a video to be streamed at each bit rate. The image quality information acquiring part 25 sends the acquired image quality information to the condition determining part 27.

### (Mode Condition Acquiring Part 26)

The mode condition acquiring part 26 acquires a mode condition for a playback mode of a video to be played back on the terminal apparatus 20. In this exemplary embodiment, the mode condition includes an “image quality priority mode” in which priority is given to the image quality over the data communication amount so that the image quality increases, and a “communication amount priority mode” in which priority is given to the data communication amount over the image quality so that the data communication amount decreases. The mode condition acquiring part 26 acquires, from the user who will watch the video on the terminal apparatus 20, information on the mode condition as to which of the image quality priority mode and the communication amount priority mode is desired by the user. The mode condition acquiring part 26 sends the acquired information on the mode condition to the condition determining part 27.

The mode condition acquiring part 26 of this exemplary embodiment receives, from the user, whether to set a noise reduction mode for reducing noise that may occur when the video is played back. When the mode condition acquiring part 26 receives the setting of the noise reduction mode from the user, the mode condition acquiring part 26 sends information on the noise reduction mode to the condition determining part 27.

### (Condition Determining Part 27)

The condition determining part 27 (example of a condition determining unit) determines a bit rate, a resolution, and a frame rate of a video to be played back based on the display area size, the communication speed, the image quality information, the cache amount, and the mode condition.

In this exemplary embodiment, information for use in the determination of the bit rate and the resolution of the video to be played back differs between an initial period of playback of the video and a progressing period after an elapse of the initial period. The information for use in the determination differs, for example, because no segment data is cached in the initial period and the cache amount is not identified by the cache amount identifying part 23. —Initial Period—

In the initial period, the condition determining part 27 determines a candidate resolution of the video based on the display area size information. The condition determining part 27 of this exemplary embodiment determines, as the candidate, a resolution of the video that is equal to or lower than a screen resolution identified based on the display area size. The condition determining part 27 identifies a bit rate based on the communication speed. The condition determining part 27 determines, as a candidate, a video having a maximum bit rate that does not exceed the pre-streaming communication speed.

The condition determining part 27 determines a combination of the resolution and the bit rate that satisfies both the conditions of the candidate resolution and the maximum bit rate. —Progressing Period—

In the progressing period, the condition determining part 27 determines a bit rate and a resolution of the video to be played back based on the candidate resolution, the communication speed, and the image quality information. The condition determining part 27 has already identified the candidate resolution. Since the initial period has elapsed, the condition determining part 27 has acquired the information on the communication speed. The condition determining part 27 acquires image quality information of a segment to be played back subsequently.

When the mode condition is the image quality priority mode, the condition determining part 27 of this exemplary embodiment determines a combination of the bit rate and the resolution that maximizes the image quality based on the image quality information from among the combinations of the candidate resolution and the bit rate that does not exceed the communication speed. In this exemplary embodiment, the image quality of the video means an evaluation value based on the SSIM. In this exemplary embodiment, the maximization of the image quality means maximization of the SSIM value.

In the image quality priority mode, the condition determining part 27 of this exemplary embodiment determines the bit rate and the resolution based on the cache amount. For example, the condition determining part 27 increases or reduces the bit rate by comparing a predetermined reference amount with the video data cache amount identified by the cache amount identifying part 23. In this exemplary embodiment, the condition determining part 27 converts the cache amount into a playback time for a case in which the cached video data is played back. The condition determining part 27 sets a time such as 10 seconds as the predetermined reference amount. When the playback time of the cached video data is shorter than 10 seconds serving as the reference amount, the condition determining part 27 performs control to reduce the bit rate. When the playback time of the cached video data is longer than 10 seconds serving as the reference amount, the condition determining part 27 sets the bit rate in the combination of the bit rate and the resolution that maximizes the image quality based on the image quality information from among the bit rates that do not exceed the communication speed.

When the mode condition is the communication amount priority mode, the condition determining part 27 of this exemplary embodiment determines a combination of the bit rate and the resolution that secures an image quality equal to or higher than a reference based on the image quality information and minimizes the bit rate from among the combinations of the candidate resolution and the bit rate that does not exceed the communication speed.

In the communication amount priority mode as well, the bit rate and the resolution may be determined based on the cache amount. When the playback time of the cached video data is shorter than 10 seconds serving as the reference amount, the condition determining part 27 performs control to reduce the bit rate. When the playback time of the cached video data is longer than 10 seconds serving as the reference amount, the condition determining part 27 sets the bit rate in the combination of the bit rate and the resolution that secures an image quality equal to or higher than the reference based on the image quality information and minimizes the bit rate from among the bit rates that do not exceed the communication speed.

The condition determining part 27 sets the noise reduction mode based on the information on the noise reduction mode that is acquired from the mode condition acquiring part 26. The noise reduction mode may be set both in the image quality priority mode and in the communication amount priority mode.

When the noise reduction mode is set, the condition determining part 27 selects a combination including a lower resolution at the bit rate identified in the image quality priority mode and the communication amount priority mode.

As described above, the condition determining part 27 determines the combination of the bit rate and the resolution of the video to be played back from among the plurality of combinations of the bit rate and the resolution indicated by the bit rate information and the resolution information acquired by the video information acquiring part 21. The condition determining part 27 repeatedly determines the bit rate and the resolution at predetermined time intervals. For example, the time interval is shorter than a segment of the video that is indicated by one piece of segment data. For example, if the segment of the video that is indicated by one piece of segment data is 2 seconds, the predetermined time interval may be set to 1 second. Every time the bit rate and the resolution are determined, the condition determining part 27 sends the determined bit rate and the determined resolution to the delivery requesting part 28.

### (Delivery Requesting Part 28)

The delivery requesting part 28 (example of a transmission requesting unit) requests the server apparatus 10 to stream the video at the bit rate determined by the condition determining part 27. If the bit rate and the resolution determined by the condition determining part 27 are changed, the delivery requesting part 28 also changes the bit rate and the resolution of the video requested for streaming.

### (Segment Data Receiving Part 29)

The segment data receiving part 29 (example of an acquiring unit) receives pieces of segment data transmitted from the server apparatus 10. The segment data receiving part 29 sends the received pieces of segment data to the temporary storage part 30.

### (Temporary Storage Part 30)

The temporary storage part 30 temporarily stores the pieces of segment data received by the segment data receiving part 29 until a part of the video that is indicated by the pieces of segment data is played back.

### (Video Playback Part 31)

When the pieces of segment data are stored in the temporary storage part 30, the video playback part 31 (example of a playback unit) sequentially reads the stored pieces of segment data and sequentially plays back videos indicated by the read pieces of segment data. As described above, the pieces of segment data are encoded and therefore the video playback part 31 decodes the pieces of segment data for playback.

The video playback part 31 displays the video to be played back in the display area of the terminal apparatus 20. The display area differs depending on, for example, orientation of the terminal apparatus 20 placed vertically or laterally or user's adjustment of the size of the display area. In response to a request, the video playback part 31 sends the display area size of the video to the display area size identifying part 22.

Next, detailed description is made of an operation flow of the video delivery system 1 to which this exemplary embodiment is applied.

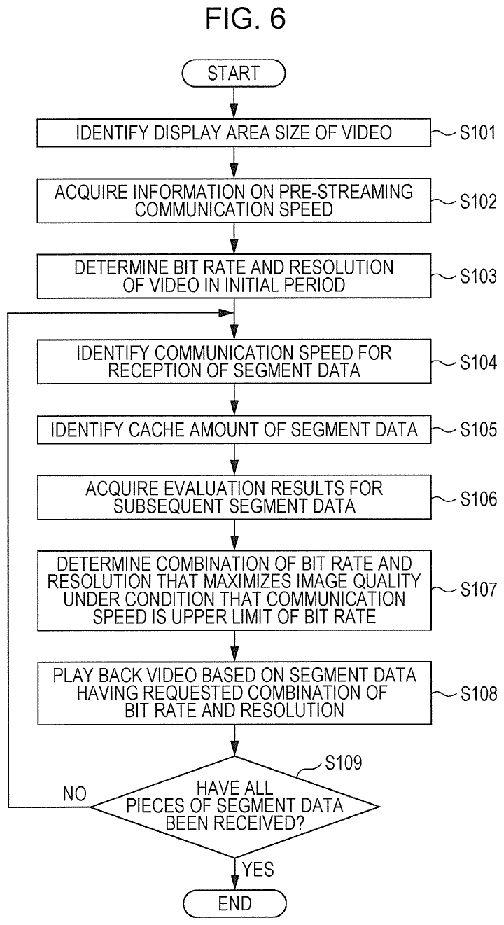

FIG. 6 is a flowchart of an operation in the image quality priority mode of the video delivery system 1 of this exemplary embodiment.

First, description is made of an operation to be performed when the user selects the image quality priority mode.

The terminal apparatus 20 starts processing related to playback of a video in response to, for example, an operation for playing back the video to be streamed as in a case in which the user performs an operation of selecting a link to the video placed on a website. The terminal apparatus 20 requests the server apparatus 10 to transmit bit rate information and resolution information of the video for which the playback operation is received.

The terminal apparatus 20 identifies the display area size of the video for which the playback operation is received (Step 101). The terminal apparatus 20 acquires information on the pre-streaming communication speed of the terminal apparatus 20 (Step 102). In the initial period, the terminal apparatus 20 determines a bit rate and a resolution based on the display area size and the pre-streaming communication speed (Step 103).

For example, when the screen resolution is 1920×1080 based on the display area size of the video, the terminal apparatus 20 sets the resolution of the video to 1920×1080 (see FIG. 4). For example, the terminal apparatus 20 sets a bit rate of 21600 Kbps based on the pre-streaming communication speed as a maximum bit rate that does not exceed the pre-streaming communication speed. In the case of the condition of this example, the terminal apparatus 20 requests the server apparatus 10 to transmit a video having a combination of the bit rate of 21600 Kbps and the resolution of 1920×1080.

Then, the server apparatus 10 transmits, to the terminal apparatus 20, pieces of segment data of the video having the combination of the bit rate and the resolution specified by the terminal apparatus 20. The terminal apparatus 20 receives the pieces of segment data and plays back the video based on the received pieces of segment data.

Next, the terminal apparatus 20 identifies a communication speed based on the data amount of the received pieces of segment data and a time required to receive the pieces of data (Step 104). The terminal apparatus 20 identifies the cache amount of pieces of segment data to be played back (Step 105). The terminal apparatus 20 acquires information on image quality evaluation results for pieces of segment data of the video to be received subsequently (Step 106).

In this exemplary embodiment, for example, videos having nine combinations of the bit rate and the resolution are prepared (see FIG. 4). In this case, the terminal apparatus 20 acquires information on the image quality evaluation results for the nine combinations in Step 106 (see FIG. 5).

The terminal apparatus 20 determines a combination of the bit rate and the resolution that maximizes the image quality under a condition that the communication speed is an upper limit of the bit rate (Step 107).

For example, it is assumed that a communication speed for previous reception of pieces of segment data by the terminal apparatus 20 is equal to or higher than 5400 Kbps and lower than 21600 Kbps. As described above, the resolution is identified as 1920×1080. In this example, a combination of the bit rate of 5400 Kbps and the resolution of 1920×1080 is determined based on the information on the image quality evaluation results illustrated in FIG. 5.

Then, the terminal apparatus 20 requests the server apparatus 10 to transmit pieces of segment data having the determined combination of the bit rate and the resolution. The terminal apparatus 20 plays back the video based on the pieces of segment data having the requested combination of the bit rate and the resolution (Step 108).

It is determined whether all the pieces of segment data of the video have been received (Step 109). When all the pieces of segment data have not been received (“NO” in Step 109), the processing returns to Step 104 and the processing up to Step 108 is repeated. When all the pieces of segment data have been received, the playback of the target video is terminated.

When the user selects the noise reduction mode in the image quality priority mode, a combination of the determined bit rate and a lower resolution at this bit rate is employed. In the example described above, a combination of the bit rate of 5400 Kbps and the resolution of 1280×720 is employed based on the information on the image quality evaluation results illustrated in FIG. 5.

Next, description is made of an operation to be performed when the communication amount priority mode is selected.

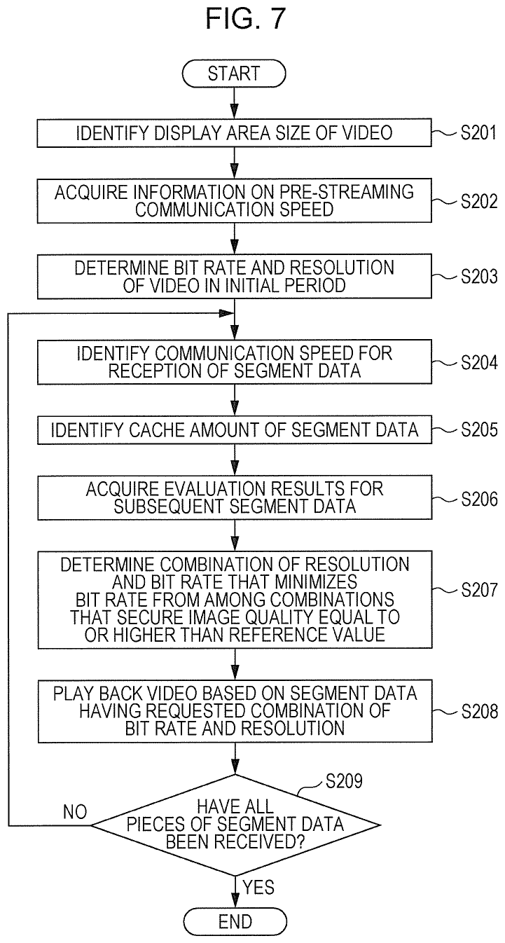

FIG. 7 is a flowchart of an operation in the communication amount priority mode of the video delivery system 1 of this exemplary embodiment.

The terminal apparatus 20 starts processing related to playback of a video in response to, for example, an operation for playing back the video to be streamed as in a case in which the user performs an operation of selecting a link to the video placed on a website. The terminal apparatus 20 requests the server apparatus 10 to transmit bit rate information and resolution information of the video for which the playback operation is received.

In the video delivery system 1 of this exemplary embodiment, processing from Step 201 to Step 206 in the communication amount priority mode is similar to the processing from Step 101 to Step 106 in the image quality priority mode. In the communication amount priority mode as well, a video resolution equal to or lower than the display area size is a candidate based on the display area size information.

In the communication amount priority mode, the terminal apparatus 20 determines, as an image quality evaluation result, a combination of the bit rate and the resolution that minimizes the bit rate from among the combinations that secure an image quality equal to or higher than a reference value (Step 207).

For example, it is assumed that a communication speed for previous reception of pieces of segment data by the terminal apparatus 20 is equal to or higher than 5400 Kbps and lower than 21600 Kbps. As described above, the resolution is identified as 1920×1080. For example, the reference value of the image quality is set to “0.95”. In this example, a combination of the bit rate of 2400 Kbps and the resolution of 1280×720 is determined based on the information on the image quality evaluation results illustrated in FIG. 5.

Then, the terminal apparatus 20 requests the server apparatus 10 to transmit pieces of segment data having the determined combination of the bit rate and the resolution. The terminal apparatus 20 plays back the video based on the pieces of segment data having the requested combination of the bit rate and the resolution (Step 208).

It is determined whether all the pieces of segment data of the video have been received (Step 209). When all the pieces of segment data have not been received (“NO” in Step 209), the processing returns to Step 204 and the processing up to Step 208 is repeated. When all the pieces of segment data have been received, the playback of the target video is terminated.

When the user selects the noise reduction mode in the communication amount priority mode, a combination of the determined bit rate and a lower resolution at this bit rate is employed. In the example described above, a combination of the bit rate of 2400 Kbps and the resolution of 640×360 is employed based on the information on the image quality evaluation results illustrated in FIG. 5.

Next, the combinations of the bit rate and the resolution of the segment data of the video stored in the server apparatus 10 are described with reference to another example of the combinations stored in the segment data storing part 12.

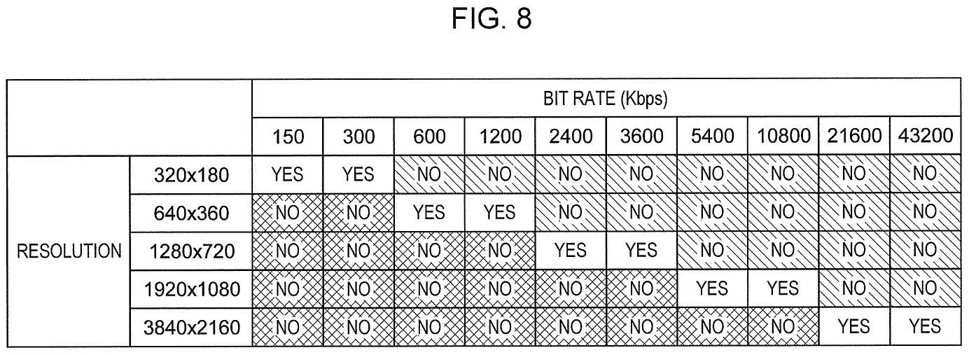

FIG. 8 illustrates relationships between the bit rate and the resolution of the segment data in the other example.

As illustrated in FIG. 8, the segment data storing part 12 of the other example stores pieces of segment data of a video having a plurality of bit rates combined with one resolution. The segment data storing part 12 stores pieces of segment data of a video having a plurality of different resolutions.

Specifically, the segment data storing part 12 of the other example stores pieces of segment data having two different bit rates combined with each of five resolutions. For example, a combination of the resolution of 320×180 and the bit rate of 150 Kbps and a combination of the resolution of 320×180 and a bit rate of 300 Kbps are provided.

The image quality evaluating part 13 obtains image quality evaluation results for the combinations of the bit rate and the resolution in the other example as well. In the example illustrated in FIG. 8, illustration of the image quality evaluation results is omitted. For example, at the same resolution, the image quality is higher when the bit rate is high than when the bit rate is low. Specifically, the image quality in the combination of the resolution of 320×180 and the bit rate of 300 Kbps is higher than the image quality in the combination of the resolution of 320×180 and the bit rate of 150 Kbps.

The image quality evaluating part 13 obtains information on the likelihood of occurrence of noise during playback of the video for the combinations of the bit rate and the resolution in the other example as well. In the example illustrated in FIG. 8, at the same resolution, the noise is less likely to occur when the bit rate is high than when the bit rate is low. Specifically, the noise is unlikely to occur in the combination of the resolution of 320×180 and the bit rate of 300 Kbps. The noise may occur in the combination of the resolution of 320×180 and the bit rate of 150 Kbps.

A video having a combination of the bit rate and the resolution that responds to the priority of the image quality or the communication amount desired by the user in the image quality priority mode or the communication amount priority mode may be delivered based on the segment data storing part 12 that stores the plurality of combinations of the bit rate and the resolution in the other example configurated as described above.

Also regarding the combinations of the bit rate and the resolution in the other example illustrated in FIG. 8, a combination of the bit rate and the resolution that reduces the likelihood of occurrence of noise may be selected from among the combinations including the same resolution in response to the setting of the noise reduction mode.

Next, description is made of still another example of the combinations of the bit rate and the resolution of the segment data of the video stored in the server apparatus 10.

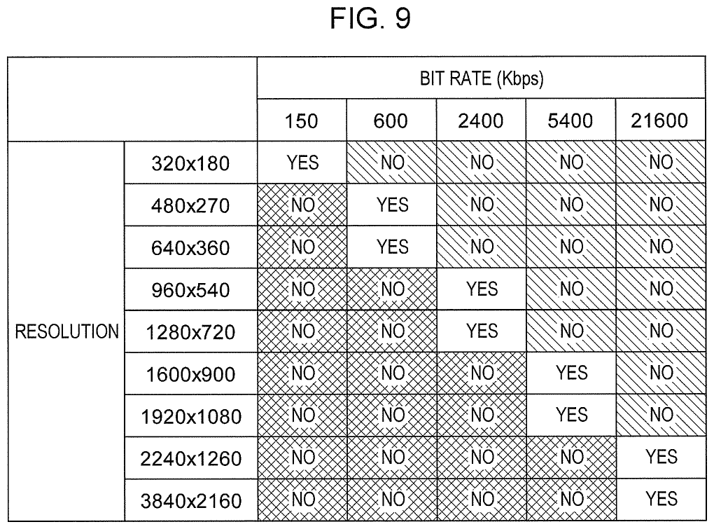

FIG. 9 illustrates relationships between the bit rate and the resolution of the segment data in the still other example.

As illustrated in FIG. 9, the segment data storing part 12 of the still other example stores pieces of segment data of a video having a plurality of resolutions combined with one bit rate. The segment data storing part 12 stores pieces of segment data of a video having a plurality of different bit rates.

Specifically, the segment data storing part 12 of the still other example stores pieces of segment data having two different resolutions combined with each of four bit rates. For example, a combination of the bit rate of 600 Kbps and a resolution of 480×270 and a combination of the bit rate of 600 Kbps and the resolution of 640×360 are provided.

The image quality evaluating part 13 obtains image quality evaluation results for the combinations of the bit rate and the resolution in the still other example as well. In the example illustrated in FIG. 9, illustration of the image quality evaluation results is omitted. For example, at the same bit rate, the image quality is higher when the resolution is high than when the resolution is low. Specifically, the image quality in the combination of the bit rate of 600 Kbps and the resolution of 640×360 is higher than the image quality in the combination of the bit rate of 600 Kbps and the resolution of 480×270.

The image quality evaluating part 13 obtains information on the likelihood of occurrence of noise for the combinations of the bit rate and the resolution in the still other example as well. In the example illustrated in FIG. 9, at the same bit rate, the noise is less likely to occur when the resolution is low than when the resolution is high. Specifically, the noise is unlikely to occur in the combination of the bit rate of 600 Kbps and the resolution of 480×270. The noise may occur in the combination of the bit rate of 600 Kbps and the resolution of 640×360.

A video having a combination of the bit rate and the resolution that responds to the priority of the image quality or the communication amount desired by the user in the image quality priority mode or the communication amount priority mode may be delivered based on the segment data storing part 12 that stores the plurality of combinations of the bit rate and the resolution in the still other example configurated as described above.

Also regarding the combinations of the bit rate and the resolution in the still other example illustrated in FIG. 9, a combination of the bit rate and the resolution that reduces the likelihood of occurrence of noise may be selected from among the combinations including the same bit rate in response to the setting of the noise reduction mode.

### Second Exemplary Embodiment

In the first exemplary embodiment, a video having a combination that responds to a user's request for the image quality priority or the communication amount priority is selected from among the combinations of the bit rate and the resolution. The selection of the combination is not limited to this example.

In a second exemplary embodiment, a specific combination may be selected from among combinations of the bit rate, the resolution, and the frame rate based on the user's request for the image quality priority or the communication amount priority.

In the second exemplary embodiment, the basic functional configurations of the server apparatus 10 and the terminal apparatus 20 are similar to those in the first exemplary embodiment (see FIG. 3).

The segment data storing part 12 of the second exemplary embodiment stores pieces of segment data of a video having a plurality of (for example, three) frame rates for one combination of the bit rate and the resolution in the first exemplary embodiment. For example, the segment data storing part 12 stores pieces of segment data of a video having frame rates of 15 fps, 30 fps, and 60 fps for the combination of the bit rate of 600 Kbps and the resolution of 320×180. For example, the segment data storing part 12 stores pieces of segment data of a video having frame rates of 15 fps, 30 fps, and 60 fps for the combination of the bit rate of 600 Kbps and the resolution of 640×360.

The frame rate is the number of frames processed per unit time and the unit is frame per second (fps).

Thus, the segment data storing part 12 of the second exemplary embodiment stores a plurality of pieces of video data having different frame rates for at least one bit rate and at least one resolution.

In the second exemplary embodiment as well, the image quality evaluating part 13 evaluates the image quality for each combination of the bit rate, the resolution, and the frame rate. The image quality evaluation in the case in which the frame rate is included is described in detail later.

For example, when the frame rate decreases, the bit rate of the video decreases. For example, if the contents of the video show relatively small motions, influence of the frame rate on the video is smaller than that of the resolution. Therefore, if the communication speed is limited, the frame rate may be reduced with higher priority over the resolution. For example, if the contents of the video show lots of motions, the resolution may be reduced with higher priority over the frame rate.

Next, description is made of the image quality evaluation for the video in consideration of the frame rate.

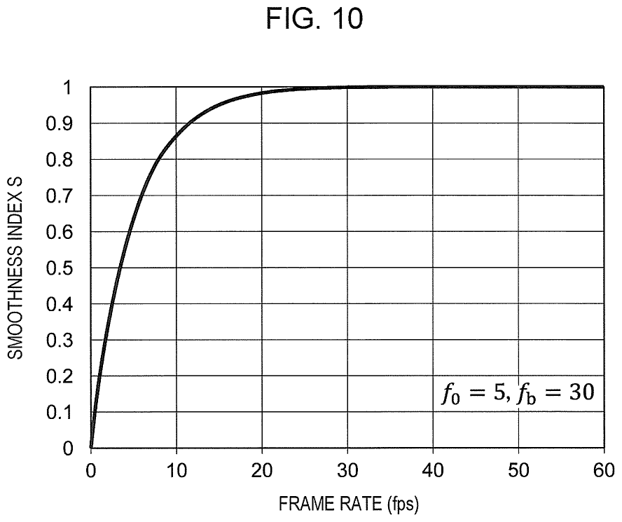

FIG. 10 illustrates a video quality index Q of the second exemplary embodiment.

In the second exemplary embodiment, the video quality index Q obtained by multiplying the SSIM being an image quality evaluation index by a smoothness index S is used for evaluation including the influence of the frame rate on the image quality of the video.

Q=SSIM×S Expression (1)

The smoothness index S is determined as follows. In the following expressions, “f” represents a frame rate, “f_{b}” represents a base frame rate that is a frame rate of an original video, and “f₀” represents a variable parameter indicating the degree of motion in a video.

For example, the smoothness index S is represented by values ranging from 0 to 1. The value “1” means that the video is smooth and the image quality of the video is high. As the value decreases, the smoothness of the video decreases and the image quality of the video decreases.

(If f<f_{b})

S={1−exp(−f/f₀)}/{1−exp(−f_{b}/f₀)} Expression (2)

(If f≥f_{b})

S=1 Expression (3)

The value of the variable parameter f₀ is high for a video showing lots of motions and is low for a video showing small motions. Examples of the parameter that determines the quality of a video include a bit rate and a compression ratio. In the video delivery system 1 of this exemplary embodiment, the degree of motion in the video is identified based on the bit rate or the compression ratio of the original video. For example, if the degree of motion in the video is identified based on the bit rate of the original video and if the bit rate of the original video is high, the video is regarded as showing lots of motions and the value of the variable parameter f₀ is increased. If the bit rate of the original video is low, the video is regarded as showing small motions and the value of the variable parameter f₀ is reduced. If the degree of motion in the video is identified based on the compression ratio and if the compression ratio of the video is high, the video is regarded as showing lots of motions and the value of the variable parameter f₀ is increased. If the compression ratio of the video is low, the video is regarded as showing small motions and the value of the variable parameter f₀ is reduced.

The example illustrated in FIG. 10 shows the smoothness index S in a case in which the variable parameter f₀ is “5” and the base frame rate f_{b} is “30”.

As illustrated in FIG. 10, when the frame rate f ranges from 0 to 30, the smoothness index S increases logarithmically as the frame rate increases.

When the frame rate f is equal to or higher than 30 that is the base frame rate f_{b}, the smoothness index S is 1. This is because the frame rate f is set equal to or higher than that of the original video.

In the second exemplary embodiment, for example, a predetermined reference value is set for the video quality index Q and a combination of the bit rate, the resolution, and the frame rate that secures a video quality index Q equal to or higher than the reference value is determined. In the second exemplary embodiment, the condition determining part 27 determines the combination of the bit rate, the resolution, and the frame rate similarly to the first exemplary embodiment.

Also in the video delivery system to which the second exemplary embodiment is applied, the terminal apparatus 20 determines one combination of the bit rate, the resolution, and the frame rate from among the plurality of combinations based on the display area size, the communication speed, the cache amount, the mode condition, and the video quality index Q. The terminal apparatus 20 requests the server apparatus 10 to deliver video data having the determined combination. The server apparatus 10 transmits, to the terminal apparatus 20, pieces of segment data having the combination of the bit rate, the resolution, and the frame rate that responds to the request from the terminal apparatus 20. The terminal apparatus 20 plays back the video based on the pieces of segment data delivered from the server apparatus 10.

Next, description is made of the hardware configurations of the terminal apparatus 20 and the server apparatus 10 of the exemplary embodiments.

Each of the terminal apparatus 20 and the server apparatus 10 of the exemplary embodiments includes a central processing unit (CPU) serving as a computing unit, a memory serving as a main memory, a magnetic disk drive (hard disk drive (HDD)), a network interface, a display mechanism including a display device, an audio mechanism, and an input device such as a keyboard and a mouse.

The magnetic disk drive stores programs of an OS and application programs. Those programs are read in the memory and executed by the CPU, thereby implementing the functions of the functional components of each of the terminal apparatus 20 and the server apparatus 10 of the exemplary embodiments.

A program causing the terminal apparatus 20 and the server apparatus 10 to implement the series of operations of the video delivery system 1 of the exemplary embodiments may be provided not only by, for example, a communication unit but also by being stored in various recording media.

In the video delivery system 1 of the exemplary embodiments, the terminal apparatus 20 determines the combination of the bit rate, the resolution, and the frame rate but the server apparatus 10 may determine the combination.

The configuration for implementing the series of functions of the video delivery system 1 of the exemplary embodiments is not limited to the examples described above. For example, all the functions to be implemented by the server apparatus 10 of the exemplary embodiments need not be implemented by the server apparatus 10. For example, the functions may partially be implemented by the terminal apparatus 20. For example, all the functions to be implemented by the terminal apparatus 20 of the exemplary embodiments need not be implemented by the terminal apparatus 20. For example, the functions may partially be implemented by the server apparatus 10.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
a video data memory that stores, for a specific video, a plurality of pieces of video data having different resolutions for at least one bit rate, a plurality of pieces of video data having different bit rates for at least one resolution, or a plurality of pieces of video data having a plurality of frame rates associated with a combination of one bit rate and one resolution;
a condition determining unit that determines, in response to a change in contents of the video, a minimum bit rate, a resolution, and a frame rate that secure a predetermined image quality or higher from among a plurality of combinations of a resolution, a frame rate, and a bit rate that does not exceed a communication speed; and
a transmitting unit that transmits, to a playback apparatus that plays back the video, video data having a combination of one bit rate, one resolution, and one frame rate from among the plurality of pieces of video data having different resolutions for at least one bit rate, the plurality of pieces of video data having different bit rates for at least one resolution, or the plurality of pieces of video data having the plurality of frame rates associated with the combination of one bit rate and one resolution.

2. The information processing system according to claim 1,
wherein the condition determining unit has a plurality of modes, and
wherein, in a mode in which priority is given to an image quality, the condition determining unit determines a combination of a bit rate and a resolution that increases the image quality from among combinations of the resolution and the bit rate that does not exceed the communication speed.

3. The information processing system according to claim 2, wherein the transmitting unit transmits video data having a high resolution from among pieces of video data having a plurality of combinations of a bit rate and a resolution that does not exceed a display size of the video on a display screen.

4. The information processing system according to claim 2, wherein the transmitting unit transmits video data having a low resolution from among pieces of video data having a plurality of combinations of a bit rate and a resolution that does not exceed a display size of the video on a display screen.

5. The information processing system according to claim 1, wherein the transmitting unit selects the one bit rate based on a data amount of data temporarily stored for a part of the video data to be played back.

6. The information processing system according to claim 5, wherein the condition determining unit reduces the one bit rate when a playback time of the video data that is based on the data amount of the temporarily stored data is shorter than a reference amount.

7. The information processing system according to claim 5, wherein, when a playback time of the video data that is based on the data amount of the temporarily stored data is longer than a reference amount, the condition determining unit determines the one bit rate in a combination of a bit rate and a resolution that maximizes an image quality based on image quality information from among bit rates that do not exceed the communication speed.

8. The information processing system according to claim 1, wherein the transmitting unit transmits video data having a frame rate that is based on information on an image quality of the specific video that is identified based on a motion shown in video contents to be played back in the video.

9. The information processing system according to claim 8, wherein, when priority is given to the image quality of the video over a communication amount, the transmitting unit transmits video data in which a resolution is reduced with higher priority over the frame rate.

10. The information processing system according to claim 8, wherein, when priority is given to a communication amount over the image quality of the video, the transmitting unit transmits video data in which the frame rate is reduced with higher priority over a resolution.

11. A terminal apparatus, comprising:
a condition determining unit that determines, in response to a change in contents of a specific video, a minimum bit rate, a resolution, and a frame rate that secure a predetermined image quality or higher from among a plurality of combinations of a resolution, a frame rate, and a bit rate that does not exceed a communication speed in a plurality of pieces of video data having different resolutions for at least one bit rate, a plurality of pieces of video data having different bit rates for at least one resolution, or a plurality of pieces of video data having a plurality of frame rates associated with a combination of one bit rate and one resolution;
a transmission requesting unit that requests, from a server apparatus that transmits video data to be streamed, transmission of video data having a combination of one bit rate, one resolution, and one frame rate from among the plurality of pieces of video data having different resolutions for at least one bit rate, the plurality of pieces of video data having different bit rates for at least one resolution, or the plurality of pieces of video data having the plurality of frame rates associated with the combination of one bit rate and one resolution;
an acquiring unit that acquires the video data from the server apparatus; and
a playback unit that plays back the video based on the acquired video data.

12. A non-transitory computer readable medium storing a program causing a computer that functions as an information processing apparatus to execute a process comprising:
storing, for a specific video, a plurality of pieces of video data having different resolutions for at least one bit rate, a plurality of pieces of video data having different bit rates for at least one resolution, or a plurality of pieces of video data having a plurality of frame rates associated with a combination of one bit rate and one resolution; and
transmitting, to a playback apparatus that plays back the video, video data having a combination of one bit rate, one resolution, and one frame rate from among the plurality of pieces of video data having different resolutions for at least one bit rate, the plurality of pieces of video data having different bit rates for at least one resolution, or the plurality of pieces of video data having the plurality of frame rates associated with the combination of one bit rate and one resolution.

13. A non-transitory computer readable medium storing a program causing a computer that functions as a terminal apparatus to execute a process comprising:
determining, for a server apparatus that transmits video data to be streamed, in response to a change in contents of a specific video, a minimum bit rate, a resolution, and a frame rate that secure a predetermined image quality or higher from among a plurality of combinations of a resolution, a frame rate, and a bit rate that does not exceed a communication speed in a plurality of pieces of video data having different resolutions for at least one bit rate, a plurality of pieces of video data having different bit rates for at least one resolution, or a plurality of pieces of video data having a plurality of frame rates associated with a combination of one bit rate and one resolution;
acquiring the video data from the server apparatus; and
playing back the video based on the acquired video data.
